(19) United States
(12) Patent Application Publication
(10) Pub. No.: US 2008/0166902 A1
(43) Pub. Date: Jul. 10, 2008

(54) DONGLE DEVICE

(75) Inventors: Kevin M. JOHNSON, Natick, MA (US); Terrence K. JONES, Jamestown, RI (US); Michael W. McChesney, Elkins, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: NEWTON PERIPHERALS, LLC, Natick, MA (US)

(21) Appl. No.: 11/969,213

(22) Filed: Jan. 3, 2008

Related U.S. Application Data
(60) Provisional application No. 60/883,261, filed on Jan. 3, 2007.

(51) Int. Cl. H01R 13/44

(52) U.S. Cl. 439/133

(57) ABSTRACT

The present disclosure relates to a dongle device that is geometrically configured to provide for more efficient engagement with a host computer and which may provide for improved protection of dongle circuitry. The dongle design may be applied to incorporate any additional hardware/software functionality to the computer, such as retrofit wireless connectivity.

### CROSS-REFERENCE TO RELATED APPLICATIONS

The present application claims the benefit of U.S. Provisional Application No. 60/883,261 filed on Jan. 3, 2007, the teachings of which are incorporated herein by reference.

### FIELD OF INVENTION

The present disclosure relates to a dongle device that is geometrically configured to provide more efficient engagement with a host computer which may then provide for improved protection of dongle circuitry. The dongle device may specifically provide retrofit wireless connectivity and be less prone to damage when employed in a portable laptop computer environment. In addition, the dongle may provide protection for the receptacle and therefore the laptop or portable device into which the dongle is provided.

### BACKGROUND

The portable computer market appears to continue to grow and to now outpace the desktop pc market. People want computing mobility that replicates the power and convenience of their home or office computer. However, many laptop devices may still be configured without built-in wireless networking connectivity. Among the retrofit options that are available include, e.g., Bluetooth retrofitting, which may provide a clip-on module or dongle and which may utilize a USB port on the computer as a hardwired point of connectivity.

Conventional Bluetooth retrofit dongle devices that engage with the USB port typically are of a design as shown in FIG. 1. Such devices 10 include a connector portion 12 which includes the standard pin connectors suitable for USB type connectivity. In addition, such devices include connector portion 12 which is designed to be fit partially or entirely within the computer housing and body portion 14. The body portion may include the PC board and other electrical components and an antenna.

### SUMMARY

An aspect of the present disclosure relates to a dongle. The dongle may include a connector portion, wherein the connector portion is configured to be received in a receptacle. In addition, the connector portion may have a first length L₁ and the receptacle may have a second length L₂, wherein L₁ is less than L₂. The dongle may also include a PC board including a plurality of contacts at least partially located within the connector portion and an electrical component in electrical communication with the contacts.

Another aspect of the present disclosure relates to a dongle configured to be received in a housing wherein the housing includes a receptacle and a surface. The dongle may include a head section and a connector portion, wherein the connector portion may be configured to be received in the receptacle. Furthermore, the head section may include a surface portion configured to abut the surface of the housing.

A further aspect of the present invention relates to a dongle configured to be received in a housing, wherein the housing may include a receptacle and a surface and the dongle may be configured to be inserted in a direction into the housing. The dongle may include a head section including at least one profile and a connector portion configured to be received in the receptacle, wherein a line tangent to any portion of at least 50% of the at least one profile forms an acute angle with a plane that is perpendicular to the insertion direction of the connector.

### BRIEF DESCRIPTION OF THE DRAWINGS

The detailed description below may be better understood with reference to the accompanying figures which are provided for illustrative purposes and are not to be considered as limiting any aspect of the disclosure.

FIG. 1 is a perspective view of a known dongle device designed to engage with a USB port of a computer.

FIG. 2 is an exemplary embodiment of a cross-section of the dongle device of the present disclosure.

FIG. 3 is another exemplary cross-sectional view of the dongle device of the present disclosure.

FIGS. 4a and 4b is another exemplary cross-sectional view of the dongle device.

FIG. 5a is a perspective view of the dongle device emphasizing certain contoured surfaces.

FIG. 5b is a cross-sectional view of the dongle device emphasizing certain contoured surfaces.

FIG. 6 is a cut-away view of the dongle device engaged with a computer housing.

FIG. 7 is a cut away view of the dongle device illustrating a possible placement of an antenna within the dongle when the dongle is configured to provide retrofit wireless connectivity.

FIGS. 8 & 9 provide an illustration of a dongle device consistent with the present disclosure including a flexible antenna.

FIG. 10 provides an illustration of a dongle device that may be customized by a user for a given laptop.

FIG. 11 provides an illustration of dongle device showing the optional placement of all or a portion of dongle electronics.

FIG. 12 provides an illustration of a dongle device that may also be customized by a user for a given laptop.

### DETAILED DESCRIPTION

The present disclosure relates to a dongle device that is geometrically configured to provide for more efficient engagement with a computer. By more efficient engagement, it may be understood that the dongle device is geometrically configured so that dongle circuitry may be better protected when engaged with a computer and the dongle may also be of a reduced or relatively compact design so that it is may be less susceptible to damage when in use. The dongle design disclosed herein may be applied to incorporate any particular additional hardware/software functionality to the computer, such as expanded memory in the form USB memory stick, wireless connectivity, etc.

Accordingly, in an exemplary and non-limiting embodiment, the dongle is described and illustrated herein as a wireless protocol enabled device which may be connected to a computer, such as a laptop computer, to provide for the wireless exchange of information. Such wireless protocol may include any wireless communication suitable for use with a personal or laptop computer and may therefore include Bluetooth or Wi-Fi radio communication.

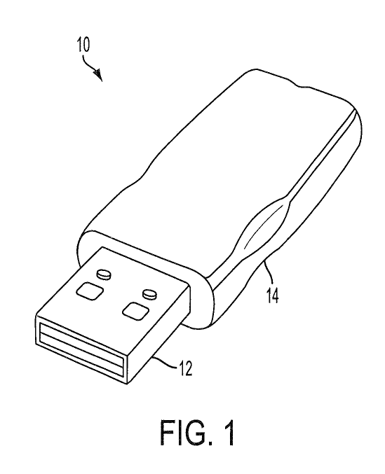

FIG. 1 illustrates a known and prior art dongle device 10. Such devices typically include connector portion 12 that is inserted partially or even completely within a host computer such that body portion 14 protrudes outward. As a consequence it may be appreciated that when utilized in a laptop type computer, and a force is introduced that is generally perpendicular to the body 14, it may disrupt the electrical connection with the computer as well as cause damage to the device itself. For example, the relatively straight-forward procedure of simply inserting a laptop computer in a laptop carrier (e.g. laptop storage bag) may lead to the development of a perpendicular (shearing) type force on body 14 when the body 14 extends beyond the storage compartment and the walls of the compartment engage the device. This force also creates a significant moment (torsional load) around the connector interface. This may often lead to removal and loss of the device or damage of the connector portion 12. It may also lead to damage to the port in which the device 10 may be connected.

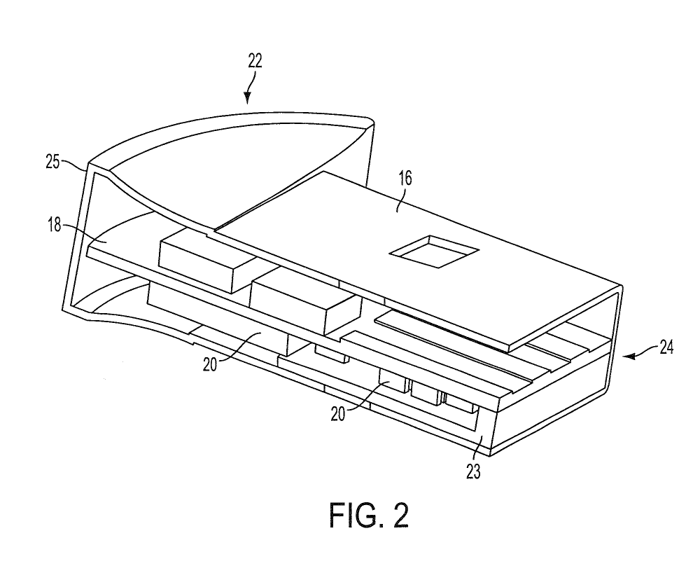

FIG. 2 provides a cross-sectional view of an exemplary dongle according to the present disclosure. As can be seen, the dongle may now include a connector portion 16 and head section 22 defining at least one profile 25, which as illustrated may be of curved design, and connector end 24 which is designed to engage within a computer. As seen in the figure, the curved surface may include an arc extending or opposite to the connector portion. The arc may extend a full 180 degrees, as illustrated, or may be less than 180 degrees, in the range of 90 to 180 degrees, including all values and increments therein.

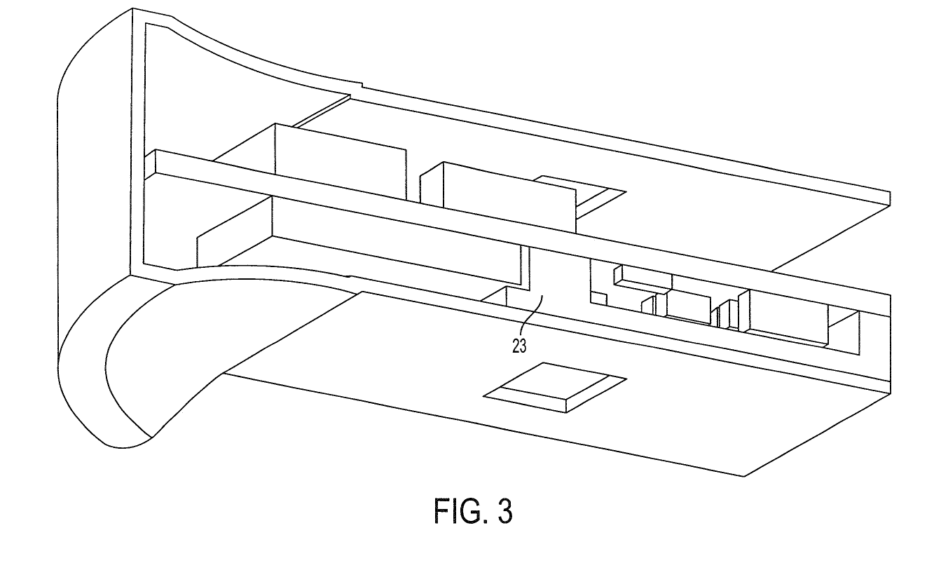

The dongle may also include a PC board 18 and electrical components 20 positioned on one side of the board. In addition, the dongle may include a protective cover 23 which may be made of polymeric (plastic) material. As illustrated in FIG. 3, the protective cover 23 may also provide support for the PC board component 18.

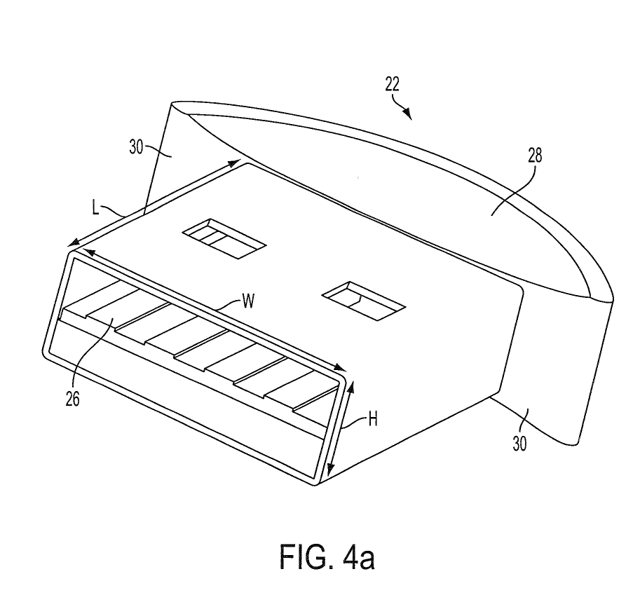

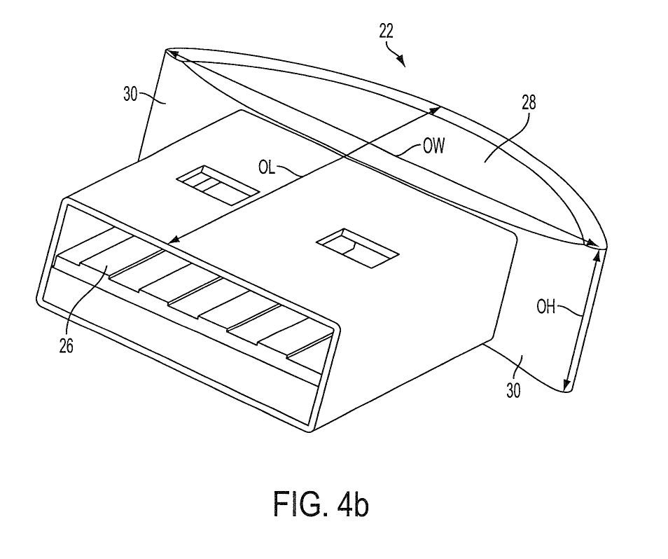

With attention next directed to FIG. 4a, the dongle device can again be seen along with contacts at 26 for engagement to a USB port. In addition, the curved head section 22 can again be seen along with a contoured surface, which may include a depression 28 that may be configured to accommodate all or a portion of a user's thumb or finger to assist in removal of the dongle from a given computer port. In one preferred embodiment, as the user pinches the top and bottom concave surfaces and leverages the tips of the fingers against the host computer housing to facilitate removal. In addition, it may be appreciated that rather than a contoured surface or a depressed surface, the head section may include other surface features such as one or more raised portions, which may include ribs, nubs, etc.

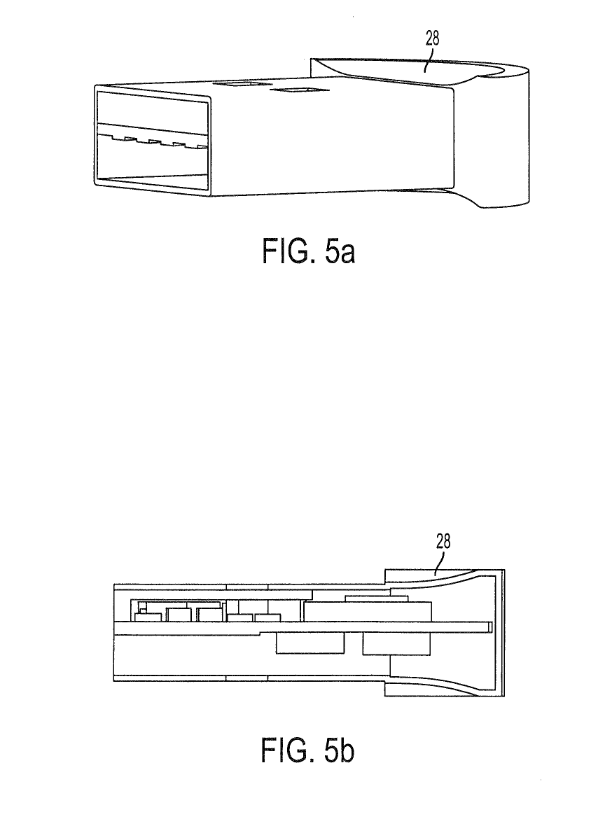

The dongle also is illustrated to contain relatively flat surfaces 30 that may be configured to engage and contact against a corresponding surface of the computer when the dongle is engaged to the computer. The relatively flat surfaces 30 may therefore be varied in surface area as needed to provide optimum mechanical stability to the dongle when abutting corresponding surfaces of a given computer housing. For example, the relatively flat surfaces 30 may extend well-beyond the width (W) of the connector portion (see arrow “W” in FIG. 4a). In addition, relatively flat surfaces 30 may also extend beyond the height of the connector portion (see arrow “H” in FIG. 4a). As shown in FIG. 4a, a small portion of relatively flat surface 30 may be seen on the lower portion of the connector which may similarly provide another abutting surface when the connector is connected to a given host computer device. The flat surfaces of the dongle housing can be set up to contact the laptop housing and determine the exact location of the dongle before the electrical connector bottoms out. This may ensure that an external load is transferred to the host computer housing and not the receiving electrical connector or circuit board. An additional perspective view of the contoured surfaces of the dongle including depression 28 is provided in FIGS. 5a and 5b.

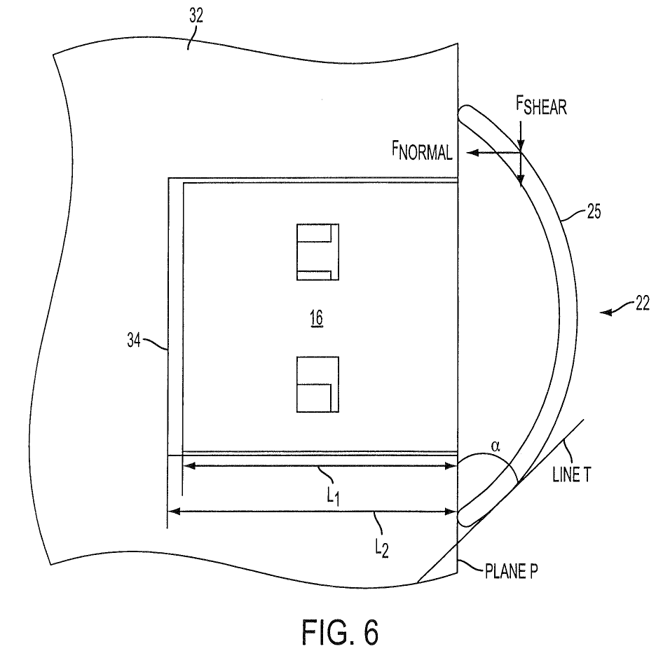

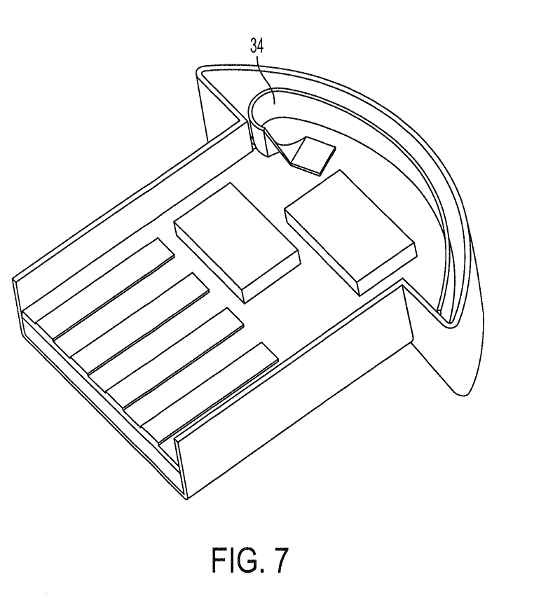

FIG. 6 provides a cut-away perspective view of the dongle device within a computer housing 32. As can be seen, a portion of the head section 22 may lie substantially flush with the computer housing surface when connector portion 16 is positioned within the computer 32. It can therefore be appreciated that the connector portion, containing associated electrical components, is now better protected by virtue of being contained substantially within the computer as opposed to protruding outward and being generally exposed.

In addition, as illustrated by the accompanying arrows, should a shear type force (Fₛₕₑₐᵣ) be presented to the curved head section 22, the geometry of the head section is such that it may lead to the development of a normal force (Fₙₒᵣₘₐₗ) perpendicular to the shear force to thereby force the dongle into the computer. Accordingly, when the dongle is connected to a laptop computer, and the user chooses to leave the dongle in place during storage, and when the edge of the laptop is exposed to a shear force, the dongle will actually experience a normal force component that may drive the dongle into the laptop housing and minimize or prevent damage or loss to the dongle, or the laptop PC board. Furthermore, it can be appreciated that the normal force component that may be realized herein can be controlled by adjustment of the profile 25 of head section 22.

In such a manner, it may be appreciated that at least one profile of the head section may be defined such that a line tangent (Line T) to any portion of at least 50% or more of the profile, including all values and increments therein in the range of 50% to 100%, may form an acute angle α with a plane that is perpendicular (Plane P) to the insertion direction of the connector. Acute angle α may be any angle less than 90 degrees, including all values and increments in the range of 0 to 90 degrees, such as 0 to 60 degrees or 0 to 45 degrees. For example, a may be selected such that, as noted above, shear type forces to the curved head section are converted to a normal force to force the dongle into the computer.

Furthermore, it may be appreciated that the connector portion of the dongle (item 16 of FIG. 2) may be designed such that the connector does not bottom out in the receptacle slot 34. In other words, the length of the connector portion L₁ may be shorter than the corresponding length of the receptacle slot 34 L₂, wherein L₁<L₂, such that the mechanical stop may be provided by the flat surface of the head section 22 abutting the housing 32. It should be appreciated that L₂ may be understood as the distance from an outside surface of the housing where a surface of the dongle (e.g. as illustrated, a surface of the head section 22) abuts a surface of the housing 32 and extends to the surface of the receptacle slot that would otherwise limit insertion of the dongle. For example, the length of the connector may be less than 12.0 mm including all values and increments in the range of 4 to 10.5 mm. Thus, when the dongle is connected to laptop computer, and the user chooses to leave the dongle in place during storage and a shear or normal force occurs on the dongle, the dongle may not forcibly contact the end of the receptacle and damage either the receptacle and/or connector and/or the circuit board to which the connector is attached.

In one example, referring to FIG. 4b, the dongle may have an overall length (OL), including both the connector and head section, of less than 25.4 mm, including all values and increments therein, for example, the overall length of the dongle may be in the range of 12.5 to 25.4 mm. The overall width (OW) of the dongle may be in the range of 10.0 to 38.5 mm, including all values and increments therein, for example, the overall width of the dongle may be between 15 and 22 mm. The overall height (OH) of the dongle may be in the range of 3 to 12.5 mm, including all values and increments therein, such as 9 to 12 mm. In addition, the dongle may weigh less than 50 grams, including all values and increments in the range of 5 to 50 grams.

As noted above, the dongle device herein may be one that specifically provides wireless retrofit capability. As illustrated in FIG. 7, in such event, an antenna may be included which antenna may be conveniently attached (e.g. soldered) to the PC board within the dongle device. In one example, the antenna may be a chip antenna affixed to the PC board. In addition, as shown, the antenna may be conveniently positioned within the curved head section 22 and therefore may remain as far outside the computer housing as possible for optimal signal transmission and reception characteristics 32.

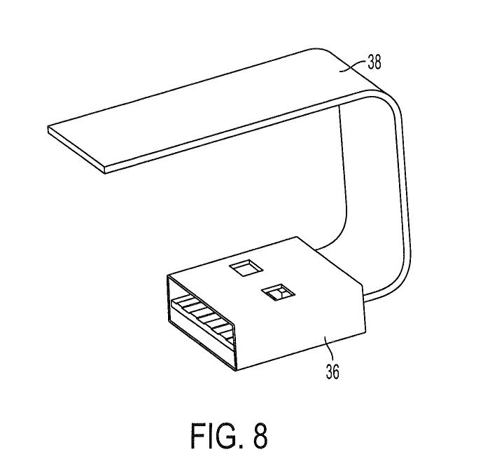

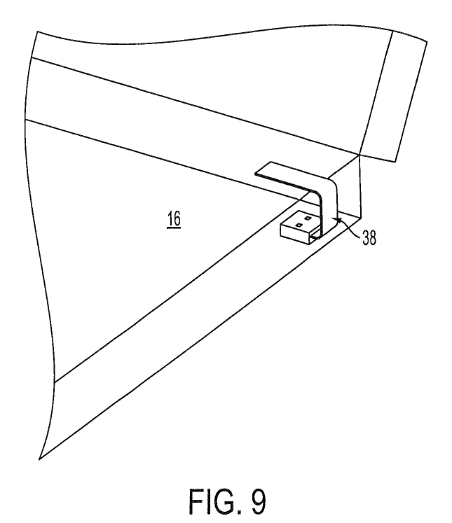

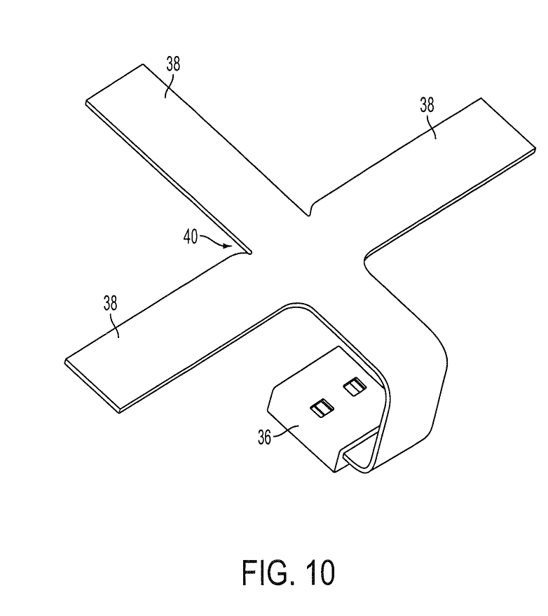

FIGS. 8 and 9 illustrate another dongle device of the present disclosure. Such device may again include a connector portion 36 which for clarity, is not shown with optional curved head section 22. As seen, the dongle device may now contain a flexible antenna component 38 that may extend outward of the dongle device and as shown in FIG. 9, be designed to wrap around the edge of the laptop for attachment via adhesive or other means to a convenient laptop surface—top, bottom, side . . . etc 16. Other variations of this concept are illustrated in FIG. 10. In this exemplary embodiment, the flexible antenna 38 may include a plurality of arm sections which may optionally include a notch or similar mechanical feature to facilitate removal of the arm sections. In such manner, a user may conveniently remove those arm sections of choice as it is only necessary to provide one arm section to ensure that a sufficient amount of antenna is present for wireless connectivity. As may be appreciated, this design provides for more optimum placement of the dongle/antenna configuration for a given computer laptop.

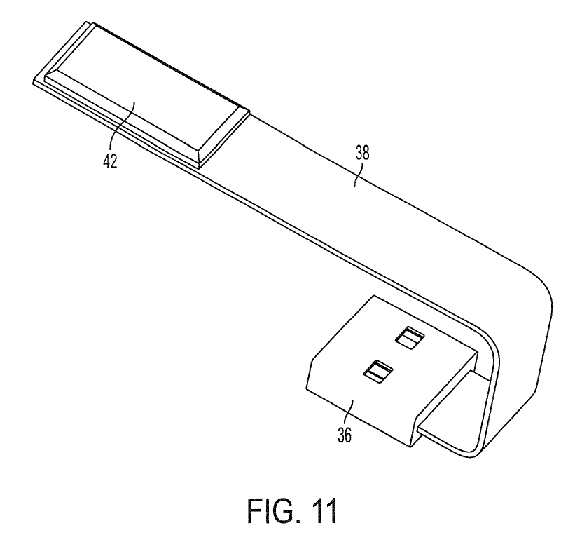

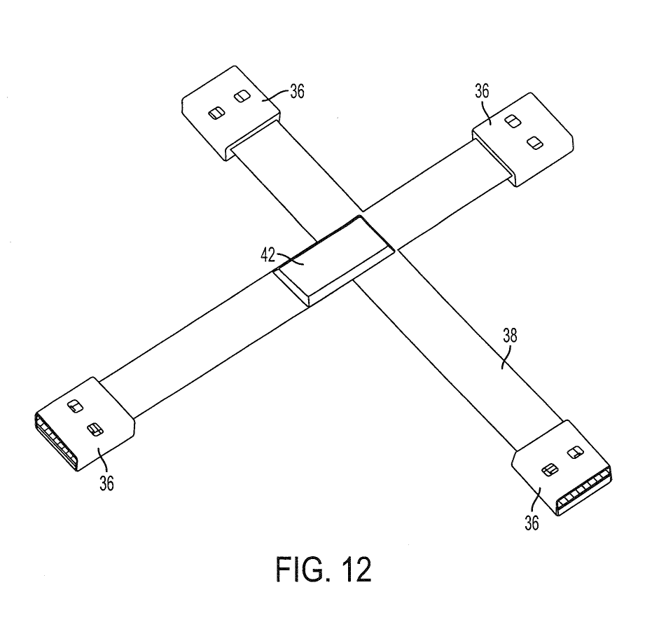

Expanding upon the above, attention is directed to FIG. 11, which illustrates that one may incorporate all or a portion of the electronics 42 required wireless connectivity, on a surface of the antenna 38. In such embodiment, the electronics may 42 may be housed in a relatively strong and durable housing that is attached to the antenna, as illustrated. Finally, attention is directed to FIG. 12 which illustrates the use of redundant connector 36 and antenna portions 38 which again may be removed by the user to optimize fit with a user's laptop.

The foregoing description is provided to illustrate and explain the present invention. However, the description hereinabove should not be considered to limit the scope of the invention set forth in the claims appended here to.

What is claimed is:

1. A dongle comprising:
a connector portion, wherein said connector portion is configured to be received in a receptacle and wherein said connector portion has a first length L₁ and said receptacle has a second length L₂, wherein L₁ is less than L₂;
a PC board including a plurality of contacts at least partially located within said connector portion; and
an electrical component in electrical communication with said contacts.

2. The dongle of claim 1, further comprising an antenna in electrical communication with said electrical component, wherein said dongle is configured to provide Bluetooth or other wireless communication.

3. The dongle of claim 2, wherein said antenna is located in said head section.

4. The dongle of claim 2, wherein said antenna extends from said connector.

5. The dongle of claim 2, wherein said electrical component is provided on said antenna.

6. The dongle of claim 5, further comprising a housing for said electrical component.

7. The dongle of claim 2, wherein said antenna includes an adhesive, configured to affix said antenna to a surface.

8. The dongle of claim 2, wherein said antenna is flexible.

9. The dongle of claim 2, wherein said antenna comprises one or more detachable portions.

10. The dongle of claim 2, further comprising a plurality of detachable connector portions and a plurality of detachable antennas in electrical communication with said electrical component.

11. The dongle of claim 1, further comprising a head section.

12. The dongle of claim 11, wherein said head section is curved and forms an arc extending from said connector portion.

13. The dongle of claim 11, wherein said head section includes at least one contoured surface.

14. The dongle of claim 11, wherein said head section includes at least one raised portion.

15. The dongle of claim 11, wherein said head section includes a surface defining a depression therein.

16. The dongle of claim 11, wherein said connector has a perimeter, and at least a portion of said head section extends beyond said perimeter.

17. The dongle of claim 11, further comprising a protective cover forming said head section.

18. The dongle of claim 17, further comprising a PC board for mounting said electronics and a protective cover, to which said PC board may be mounted.

19. The dongle of claim 11, wherein said receptacle is positioned in a housing and wherein said head section includes a surface and said connector portion is configured to be received in said receptacle wherein said head section surface is configured to abut said housing.

20. The dongle of claim 19, wherein said head section surface provides a mechanical stop.

21. The dongle of claim 1, wherein said dongle is configured to provide memory.

22. The dongle of claim 1, wherein said connector portion is less than 12.0 mm in length.

23. A dongle configured to be received in a housing wherein said housing includes a receptacle and a surface, said dongle comprising
a head section and a connector portion, wherein said connector portion is configured to be received in said receptacle and wherein said head section includes a surface portion configured to abut said surface of said housing.

24. The dongle of claim 23, wherein said head section is curved and forms an arc extending from said connector portion.

25. The dongle of claim 23, wherein said head section includes at least one contoured surface.

26. A dongle configured to be received in a housing, wherein said housing includes a receptacle and a surface and said dongle is configured to be inserted in a direction into said housing, wherein said dongle comprises
a head section including at least one profile;
a connector portion;
wherein said connector portion is configured to be received in said receptacle;
wherein a line tangent to any portion of at least 50% of said at least one profile forms an acute angle with a plane that is perpendicular to the insertion direction of the connector.
